(19) United States
(12) Patent Application Publication
(10) Pub. No.: US 2006/0262719 A1
(43) Pub. Date: Nov. 23, 2006

(54) Method of blank-and-burst signaling

(76) Inventors: Binshi Cao, Whippany, NJ (US); Mahmoud Ragah Sherif, Whippany, NJ (US)

Correspondence Address: WILLIAMS, MORGAN & AMERSON, 10333 RICHMOND, SUITE 1100, HOUSTON, TX, 77042, US

(21) Appl. No.: 11/131,798

(22) Filed: May 18, 2005

(51) Int. Cl. H04L 12/26; H04Q 7/00

(52) U.S. Cl. 370/229; 370/329

(57) ABSTRACT

The present invention provides a method of wireless communication on a first channel. The method may include delaying transmission on the first channel of a first frame provided by a first application based on at least one data rate associated with at least one second frame to be transmitted on the first channel. The at least one second frame is provided by a second application.

### BACKGROUND OF THE INVENTION

1. Field of the Invention

This invention relates generally to a communication system, and, more particularly, to a wireless communication system.

2. Description of the Related Art

Wireless communication systems typically include one or more base stations (or node-Bs) that provide wireless connectivity to mobile units (or user equipment) within one or more associated geographic areas or cells. Exemplary mobile units include cellular telephones, personal data assistants, smart phones, laptop computers, text messaging devices, and the like. Many wireless communication systems, and the associated mobile units, support concurrent voice and data transmission. For example, wireless communication systems and mobile units may allow concurrent transmissions of speech packets according to a Service Option 60 Voice over Internet Protocol (VoIP) and packet data according to Service Option 33.

Service Option 60 defines a variable rate Voice over Internet Protocol service option for transport of header-removed Internet Protocol/User Datagram Protocol/Real-time Transport Protocol (IP/UDP/RTP) packets that may carry speech frames. The Service Option 60 may also be referred to as a Link-Layer Assisted (LLA) Service Option. The LLA service options each provide one-way or two-way voice communications by providing for transport of header-removed packets between base stations and mobile units. Header removal is a technique that is typically used to support mobile units that require transport of encoded speech directly from a multiplex sub-layer to a speech encoder/decoder. When the connected service is a Voice over Internet Protocol service, speech frames are transported over a Forward Channel (FCH) in a similar fashion as the existing circuit switched application. In the forward direction, the Internet Protocol for the voice bearer transport may be terminated at the Packet Data Serving Node. In the reverse direction, the Internet Protocol packets for the voice bearer transport originate at the Packet Data Serving Node.

The base stations typically connect the service option to a Packet Control Function (PCF) and from there to a Packet Data Serving Node (PDSN), where header removal takes place. The LLA service options are designed for the transport of voice application data between mobile units and a corresponding node on the Internet Protocol network. Accordingly, the LLA service options typically require use of an associated packet data service option instance (such as Service Option 33) connected to the same Packet Data Serving Node. For Service Option 33, packet data may use the Fundamental Channel, a Supplemental Channel, or both channels. For example, when the Supplemental Channel is triggered by an application using Service Option 33, set up of the Supplemental Channel will be triggered by a signaling message (such as in Extended Supplemental Channel Assignment Message, or ESCAM) transmitted over the Fundamental Channel.

If another application is transmitting speech frames over the Fundamental Channel concurrently with transmission of the signaling message, one or more of the speech frames may be blanked. For example, an application may be transmitting speech frames according to Service Option 60 Voice over Internet Protocol at the same time as another application causes a Service Option 33 ESCAM message to be transmitted. Since both messages are transported over the Forward Channel, the Service Option 60 Voice over Internet Protocol speech frame will be blanked. In some implementations of Service Option 33, three copies of the same ESCAM message may be transmitted in a row, which would cause three consecutive speech frames to be blanked, leading to approximately 60 ms of speech frames that do not get delivered to the decoder. Blanking this number of speech frames may cause a considerable amount of voice quality degradation for the Voice over Internet Protocol session. The voice quality degradation can become much more acute when FULL rate frames are blanked at the beginning of a word/talk spurt.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for wireless communication on a first channel. The method may include delaying transmission on the first channel of a first frame provided by a first application based on at least one data rate associated with at least one second frame to be transmitted on the first channel. The at least one second frame is provided by a second application.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates one exemplary embodiment of a wireless communication system, in accordance with the present invention;

FIG. 2 conceptually illustrates one exemplary embodiment of a transmission module that may be used in the wireless communication system shown in FIG. 2, in accordance with the present invention;

FIG. 3 conceptually illustrates one exemplary embodiment of a method of delaying frames based upon a data rate associated with another frame, in accordance with the present invention; and

FIGS. 4A and 4B conceptually illustrate exemplary embodiments of streams of speech frames, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

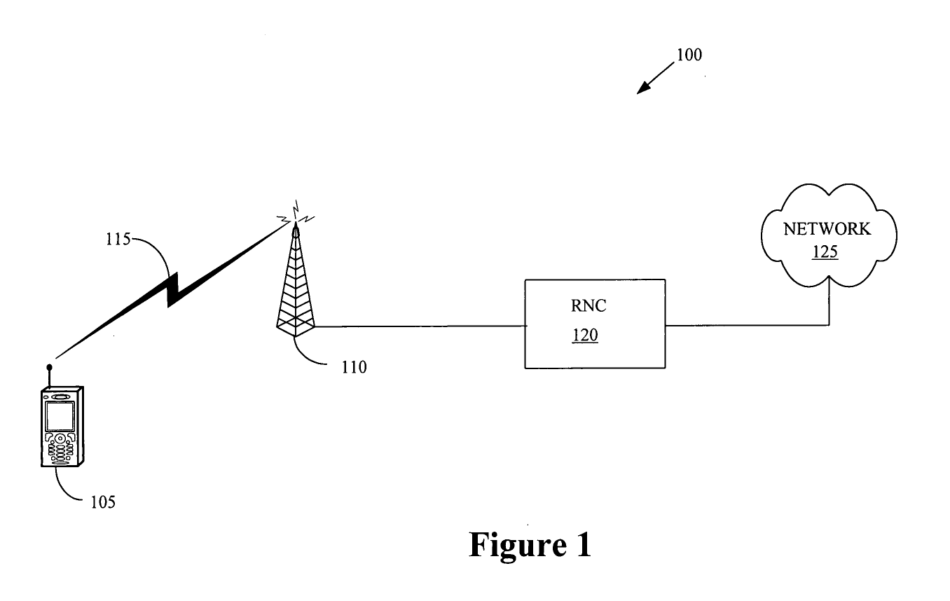

FIG. 1 conceptually illustrates one exemplary embodiment of a wireless communication system 100. In the illustrated embodiment, a mobile unit 105 communicates with a base station 110 over a wireless communication link 115, which may be formed according to any protocol or combination of protocols. Exemplary wireless communication protocols include, but are not limited to, a Universal Mobile Telecommunication System (UMTS) protocol, a Global System for Mobile indications (GSM) protocol, a Code Division Multiple Access (CDMA, CDMA 2000) protocol, and the like. Although a single mobile unit 105 and a single base station 110 are shown in FIG. 1, persons of ordinary skill in the art having benefit of the present disclosure should appreciate that, in alternative embodiments, additional mobile units 105 and/or base stations 110 may be included in the wireless communication system 100.

The base station 110 is communicatively coupled to a radio network controller (RNC) 120, which is communicatively coupled to a network 125. Techniques for operating the radio network controller 120 and the network 125 are known to persons of ordinary skill in the art and so only those aspects of the operation of these devices that are relevant to the present invention will be discussed further herein. Persons of ordinary skill in the art having benefit of the present disclosure should also appreciate that, in alternative embodiments, the wireless communication system 100 may include other elements that are not shown in FIG. 1, such as a base station controller, a Packet Control Function (PCF), a Packet Data Serving Node, and the like.

The mobile unit 105 and/or the base station 110 can transmit information provided by one or more applications over one or more channels of the wireless communication link 115. In one embodiment, the mobile unit 105 and/or the base station 110 implements an application that can provide a Voice over Internet Protocol service according to Service Option 60. Speech frames provided by the Voice over Internet Protocol application are transported over a Fundamental Channel (FCH) of the wireless communication link 115 to the base station 110. The mobile unit 105 provides speech frames to the base station 110 on the reverse link and the base station 110 provides speech frames to the mobile unit 105 on the forward link.

The mobile unit 105 and/or the base station 110 may also support other applications that may concurrently access the one or more channels of the wireless communication link 115. In one embodiment, the mobile unit 105 and/or the base station 110 supports applications that transmit packet data on the Forward Channel according to Service Option 33. If a Supplemental Channel of the wireless communication link 115 is triggered by an application using Service Option 33, set up of the Supplemental Channel may be triggered by a signaling message (such as an Extended Supplemental Channel Assignment Message, or ESCAM) transmitted over the Forward Channel. The mobile unit 105 provides the signaling message on the reverse link and the base station 110 provides the signaling message on the forward link.

When two or more applications attempt to transmit frames or messages concurrently over the same channel of the wireless communication link 115, one or more frames provided by one of the applications may be blanked so that one or more frames from another application may be transmitted. For example, when one application on the mobile unit 105 and/or the base station 110 attempts to transmit a speech frame over the Fundamental Channel concurrently with transmission of a signaling message by another application on the mobile unit 105 and/or the base station 110, one or more of the speech frames may be blanked. In order to reduce the degradation of a transmitted signal (such as a speech signal) that may be caused by blanking one or more frames, the mobile unit 105 and/or the base station 110 may delay transmission of a frame provided by one application (such as an ESCAM signaling frame) if a data rate associated with frames provided by another application (such as one ore more speech frames) indicates that blanking one of the frames provided by the second application may degrade the quality of the signal (such as the speech signal).

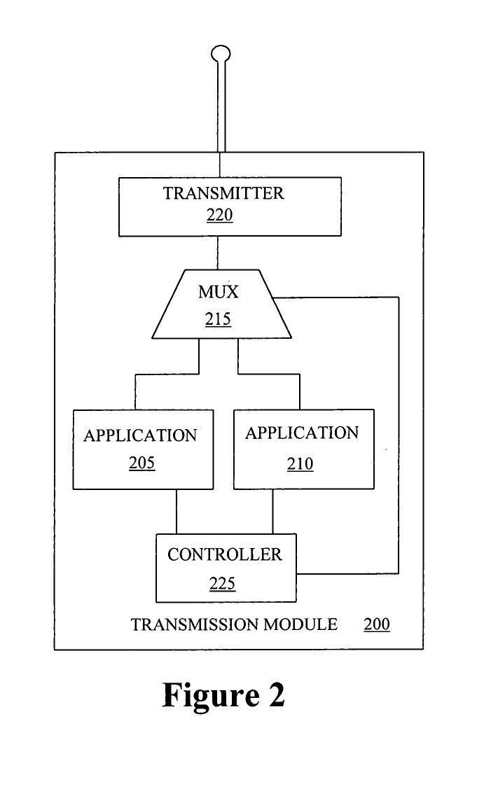

FIG. 2 conceptually illustrates one exemplary embodiment of a transmission module 200. In various alternative embodiments, the transmission module 200 may be implemented in the mobile unit 105 and/or the radio network controller 120 shown in FIG. 1. For example, a transmission module 200 implemented in the mobile unit 105 may be used to transmit frames on a reverse link and a transmission module 200 implemented in the radio network controller 120 may be used to transmit frames on a forward link. However, the present invention is not limited to these particular implementations. In alternative embodiments, portions of the transmission module 200 may be implemented in other devices. For example, the transmission module 200 may be implemented in a base station controller.

The transmission module 200 includes applications 205, 210 that provide frames to a multiplexer 215, which is coupled to a transmitter 220 for transmitting the frames over an air interface. In the illustrated embodiment, the application 205 provides frames containing delay-tolerant information and/or signals. As used herein and in accordance with common usage in the art, the term “delay-tolerant” refers to information that may be delayed before, during, or after transmission without substantially affecting the quality of the information that is transmitted and/or received. For example, data provided by an Internet server may be considered delay-tolerant information.

The application 210 provides frames containing delay-intolerant information and/or signals. As used herein and in accordance with common usage in the art, the quality of “delay-intolerant” information may be degraded if it is delayed before, during, or after transmission. For example, the quality of speech information that is formed based on speech frames provided by a device that operates according to a Voice over Internet Protocol may be degraded if the speech frames are delayed before, during, or after transmission. Persons of ordinary skill in the art should appreciate that the present invention is not limited to two applications 205, 210. In alternative embodiments, additional delay-tolerant and/or delay-intolerant applications may also be used.

A controller 225 is communicatively coupled to the applications 205, 210 and the multiplexer 215. The controller 225 can access information associated with frames provided by the applications 205, 210 and can determine when the applications 205, 210 are attempting to transmit frames concurrently over one or more channels of the air interface. If the applications 205, 210 are attempting to transmit frames concurrently over a channel, the controller 225 may delay transmission of one or more frames from the application 205, which provides delay-tolerant frames, based upon a data transmission rates associated with one or more frames provided by the application 210, which provides delay-intolerant frames. For example, if the application 205 is attempting to transmit a signaling message concurrently with one or more FULL data rate speech frames provided by the application 210, the controller 225 may delay transmission of the signaling message. When the controller 225 determines an appropriate time to transmit the one or more frames from the application 205, the controller may provide a signal to the multiplexer 215, which may multiplex the frames provided by the applications 205, 210.

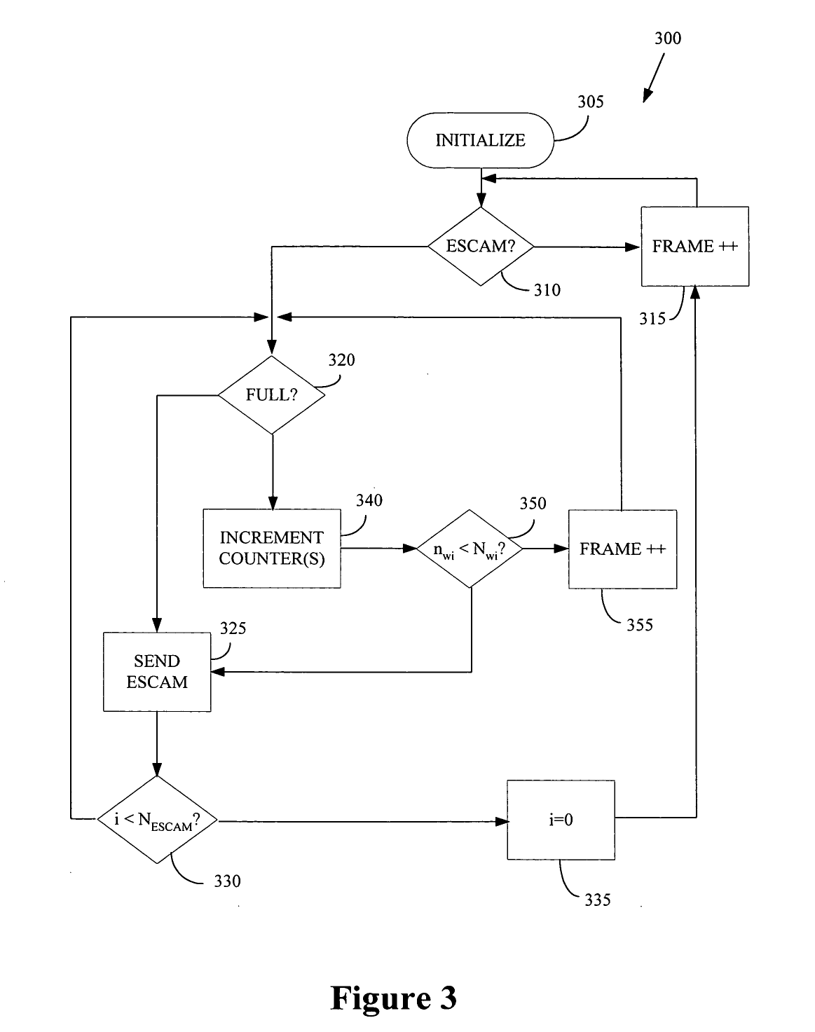

FIG. 3 conceptually illustrates one exemplary embodiment of a method 300 of delaying frames based upon a data rate associated with another frame. In the illustrated embodiment, the method 300 is used to delay one or more ESCAM messages that may be used by a first application to set up a Supplemental Channel. The delay is determined based on a data rate associated with speech frames transmitted by a second application. In the illustrated embodiment, the ESCAM messages are delayed until a non-FULL rate speech frame is detected on a Forward Channel or a predetermined time period has expired or a predetermined number of FULL data rate of speech frames have been counted. If more than one ESCAM message or frame is to be transmitted, then additional predetermined time periods or speech frame counters may be provided.

The method 300 is initialized (at 305). In one embodiment, initializing (at 305) includes setting an ESCAM message counter, i, to zero and setting the timers and/or speech frame counters to zero. For example, if three ESCAM messages or frames are to be transmitted, then the corresponding speech frame counters (n_{w1}, n_{w2}, n_{w3}) may be set to zero. If it is determined (at 310) that the first application is not attempting to transmit an ESCAM frame or message on the Forward Channel concurrently with the current speech frame, then the method 300 may advance (at 315) to the next speech frame. If it is determined (at 310) that the first application is attempting to transmit an ESCAM frame or message on the Forward Channel concurrently with the current speech frame, then the method 300 accesses information associated with the current speech frame and determines (at 320) a data rate associated with the current speech frame.

The ESCAM message or frame may be transmitted or delayed based upon the determined data rate associated with the current speech frame. In one embodiment, if the data rate associated with the current speech frame is determined (at 320) to be a non-FULL data rate speech frame, then the ESCAM message or frame may be transmitted (at 325). For example, if the data rate associated with the current speech frame is determined (at 320) to be a ⅛ data rate speech frame, then the ESCAM message or frame may be multiplexed with the speech frames (by blanking one or more of the speech frames) and then transmitted.

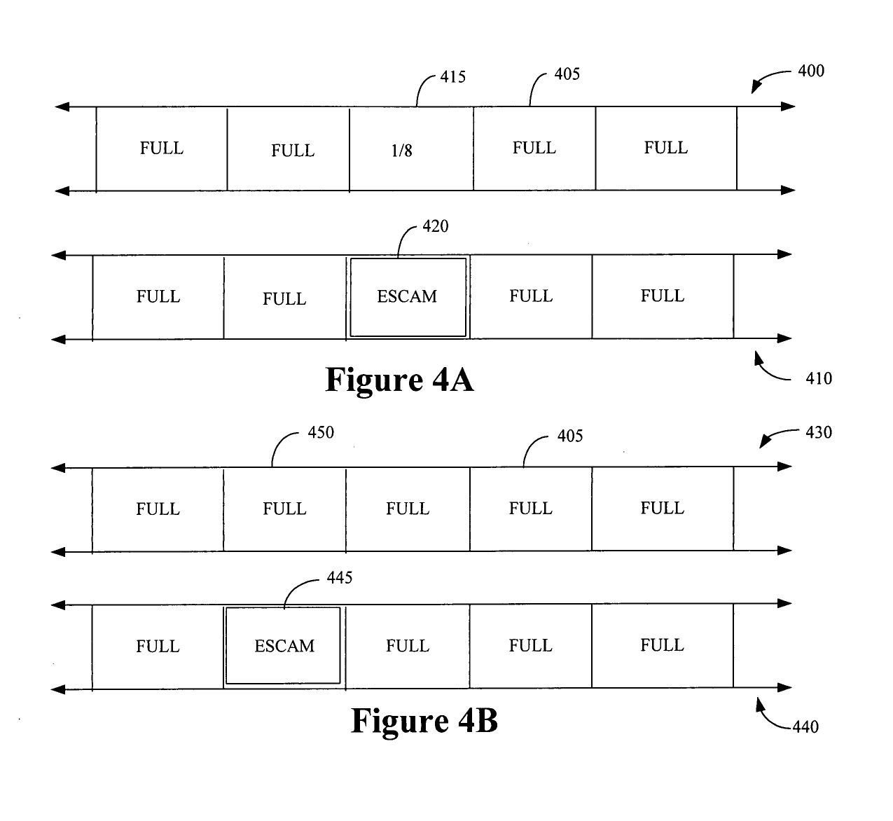

FIG. 4A conceptually illustrates one exemplary embodiment of a stream 400 of speech frames 405. FIG. 4A also shows a multiplexed stream 410 including speech frames 405 and an ESCAM frame 420 that has been multiplexed into the stream 400. In the illustrated embodiment, a ⅛ data rate speech frame 415 has been blanked so that the ESCAM frame 420 may be multiplexed into the stream 400 to form the multiplexed stream 410, which may then be transmitted over an air interface.

Referring back to FIG. 3, once an ESCAM message or frame has been sent (at 325) the method of 300 may determine (at 330) whether or not additional ESCAM frames or messages are waiting to be sent. For example, the current value of the message counter (i) may be compared (at 330) to a predetermined number of ESCAM messages or frames (N_{ESCAM}). If no additional ESCAM frames or messages are waiting to be sent, then the message counter may be set to zero (at 335) and the method 300 may advance (at 315) to the next speech frame. If additional ESCAM frames or messages are waiting to be sent, the method 300 may determine (at 320) a data rate associated with the next speech frame.

If the data rate associated with the current speech frame is determined (at 320) to be a FULL data rate speech frame, then one or more of the timers or counters may be incremented (at 340). For example, a speech frame counter (n_{wi}) associated with the current message counter (i) may be incremented (at 345). Alternatively, a timer may be incremented (at 345). The speech frame counter (n_{wi}) may then be compared (at 350) to a predetermined maximum value of the speech frame counter (N_{wi}) If the speech frame counter (n_{wi}) is less than the predetermined maximum value of the speech frame counter (N_{wi}), then the method 300 may advance (at 355) to the next speech frame. If the speech frame counter (n_{wi}) is greater than or equal to the predetermined maximum value of the speech frame counter (N_{wi}), then the ESCAM message or frame may be transmitted (at 325). For example, the ESCAM message or frame may be multiplexed with the speech frames (by blanking one or more of the speech frames) and then transmitted.

FIG. 4B conceptually illustrates one exemplary embodiment of a stream 430 of speech frames 405. FIG. 4 B also shows a multiplexed stream 440 that includes speech frames 405 and an ESCAM frame 445 that has been multiplexed into the stream 400. In the illustrated embodiment, a FULL data rate speech frame 450 has been blanked so that the ESCAM frame 445 may be multiplexed into the stream 430 to form the multiplexed stream 440, which may then be transmitted over an air interface.

Delaying transmission of the ESCAM messages or frames until a non-FULL data rate frame is detected may considerably reduce voice quality degradation caused by blanking FULL data rate frames, particularly FULL data rates each frames. Even in cases where the timer and/or counter expires and an FULL data rate frame is blanked, delaying the blanking of the FULL data rate frame may reduce the likelihood that FULL data rate speech frames at the beginning of a word/talk spurt will be blanked. Consequently, the FULL data rate speech frames that are blanked are less likely to be valuable speech frames that typically occur at the beginning of a word/talk spurt.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method of wireless communication on a first channel, comprising:
delaying transmission on the first channel of a first frame provided by a first application based on at least one data rate associated with at least one second frame to be transmitted on the first channel, said at least one second frame being provided by a second application.

2. The method of claim 1, further comprising accessing the first frame provided by the first application.

3. The method of claim 2, wherein accessing the first frame comprises accessing an Extended Supplemental Channel Assignment Message.

4. The method of claim 1, wherein delaying the first frame comprises determining said at least one data rate associated with said at least one second frame provided by the second application.

5. The method of claim 4, wherein determining the data rate comprises determining whether the data rate is a FULL data rate.

6. The method of claim 5, wherein delaying the first frame comprises delaying the first frame if the data rate is a FULL data rate.

7. The method of claim 1, wherein delaying the first frame comprises delaying the first frame for less than a maximum delay time.

8. The method of claim 1, wherein delaying the first frame comprises delaying the first frame for less than a predetermined number of frames.

9. The method of claim 1, further comprising providing the first frame on the first channel.

10. The method of claim 9, wherein providing a first fame comprises multiplexing the first frame with said at least one second frame.

11. The method of claim 10, wherein multiplexing the first frame with said at least one second frame comprises blanking one of said at least one second frame.

12. The method of claim 10, wherein blanking the second frame comprises blanking a non-FULL rate frame.

13. The method of claim 10, wherein blanking the second frame comprises blanking a FULL rate frame.

14. The method of claim 10, wherein blanking the second frame comprises blanking a speech frame.

15. The method of claim 9, wherein providing the first frame on the first channel comprises providing the first frame on a Forward Channel according to Service Option 33.

16. The method of claim 1, further comprising providing at least one second frame on the first channel.

17. The method of claim 16, wherein providing said at least one second frame on the first channel comprises providing said at least one speech frame on a Forward Channel according to Service Option 60.

18. The method of claim 1, wherein delaying the first frame comprises delaying the first frame before transmission by at least one of a mobile unit, a base station controller, and a radio network controller.
